(19) United States
(12) Patent Application Publication
(10) Pub. No.: US 2022/0258597 A1
(43) Pub. Date: Aug. 18, 2022

(54) AIR FLAP ARRANGEMENT CONFIGURED FOR ONBOARD DIAGNOSIS FOR A MOTOR VEHICLE

(71) Applicant: Röchling Automotive SE & Co. KG, Mannheim (DE)

(72) Inventor: Jürgen Schneider, Worms (DE)

(21) Appl. No.: 17/670,596

(22) Filed: Feb. 14, 2022

(30) Foreign Application Priority Data
Feb. 17, 2021 (DE) 10 2021 103 785.9

(51) Int. Cl. B60K 11/08; B60R 19/52

(52) U.S. Cl. CPC B60K 11/085; B60R 2019/525; B60R 19/52

(57) ABSTRACT

An air flap arrangement including an air flap carrier with an air outlet opening, where at the air flap carrier there are mounted movably a plurality of air flaps which project into the air outlet opening, where each air flap is adjustable between a blocked operating position and an opened operating position, where each two air flaps directly adjacent in the sequential direction are linked by one linking component for joint movement, where the air flap arrangement having a movement drive which is linked with a driving air flap for the transmission of driving force, where a first operating position out of the blocked operating position and the opened operating position is defined by a first end-stop arrangement which during specified normal operation impedes movement beyond the first operating position of a first control air flap arranged at a distance from the driving air flap for changing the flow-through cross-sectional area of the air outlet opening; only the first control air flap directly and a first group of air flaps, including the driving air flap and the intermediate air flaps which connect the driving air flap and the first control air flap with one another through linking components indirectly, are impeded by the first end-stop arrangement in their movement beyond the first operating position.

This Application claims priority in German Patent Application DE 10 2021 103 785.9 filed on Feb. 17, 2021, which is incorporated by reference herein.

The present invention concerns an air flap arrangement, comprising an air flap carrier with an air outlet opening which penetrates through the air flap carrier, where at the air flap carrier there are mounted movably a plurality of air flaps arranged following one another directly along a sequential direction, which are arranged at the air flap carrier projecting into the air outlet opening or straddling the air outlet opening, where each air flap out of the plurality of air flaps following one another directly along the sequential direction is adjustable between a blocked operating position in which the respective air flap decreases more strongly a flow-through cross-sectional area of the air outlet opening, and an opened operating position in which the respective air flap decreases less strongly the flow-through cross-sectional area of the air outlet opening, where each two air flaps directly adjacent in the sequential direction are linked by a linking component for common movement between their blocked operating position and their opened operating position, where the air flap arrangement comprises a movement drive which is linked with an air flap as a driving air flap out of the plurality of air flaps arranged following one another directly along the sequential direction for the transmission of a driving force, where a first operating position out of the blocked operating position and the opened operating position is defined by a first end-stop arrangement which during specified normal operation impedes a movement beyond the first operating position of a first control air flap arranged in the sequential direction at a distance from the driving air flap for changing the flow-through cross-sectional area of the air outlet opening.

### BACKGROUND OF THE INVENTION

Such an air flap arrangement is known from WO 2019/152520 A1. The latter discloses a connecting bridge connecting the plurality of air flaps, formed from a plurality of elements swiveling relative to one another and made of pairwise different materials. Via this multi-part connecting bridge with articulated linked elements, the plurality of air flaps following one another in a sequential direction are linked for joint swiveling movement between the blocked operating position and the opened operating position. The use of the articulated, multi-part connecting bridge serves for onboard diagnosis of the air flap arrangement in terms of its correct fulfilment of its function.

As long as all air flaps of the aforementioned plurality are present and correctly operational, the articulated connecting bridge behaves as a rigid one-piece connecting bridge. Each air flap is connected to the connecting bridge at an articulated section of the latter. At such an articulated section there are also connected with one another two adjacent elements of the articulated connecting bridge. A trunnion on the air-flap side linking the connecting bridge with the respective air flap proceeds at the operational known air flap arrangement coaxially with the relative swivel axis of the elements meeting at the respective articulated section for movement linking with these.

If one of the air flaps fails, for example because it has been destroyed by an impact and falls off the motor vehicle carrying it, the articulated connected elements can buckle at the articulated section, since then a constraint that previously was present due to the linking trunnion on the air-flap side, has ceased to exist. The local buckled state which differs from the operational stretched state of the articulated connecting bridge can, according to WO 2019/152520 A1, be checked and detected through visual inspection or through operating parameters of the movement drive not specified in further detail.

A further air flap arrangement configured for onboard diagnosis is known from DE 10 2019 112 701 A1. This publication discloses air flaps linked pairwise through a linking component, where pairwise adjacent linking components of two air flap pairs are linked with one another through a further linking component. Through latching and counter-latching formations at the linking components and at the air flap carrier, which can only come to engage with one another in the event of damage, the failure of an arbitrary air flap can also be detected in this known air flap arrangement.

Since motor vehicle air flap arrangements affect the thermal budget of the power unit in the widest sense and thus indirectly the pollutant emission behavior of the motor vehicle, the correct function of the air flap arrangements is becoming ever more crucial with increasingly strict exhaust regulations. Here it is above all important to detect reliably the failure of an air flap even when it is not connected directly with the movement drive as a driving air flap but only as a following air flap via a linkage system or gear unit.

Starting from WO 2019/152520 A1, whose air flap arrangement is very costly to construct, it is the task of the present invention to further develop the air flap arrangement mentioned at the beginning in such a way that with a simpler construction, in spite of using only one movement drive for the plurality of air flaps, the failure of an arbitrary air flap out of the plurality continues to be reliably detectable.

### SUMMARY OF THE INVENTION

The present invention solves this task in a generic air flap arrangement by having only the first control air flap impeded directly in its movement beyond the first operating position by the first end-stop arrangement during specified normal operation and by having a first group of air flaps, comprising the driving air flap and the intermediate air flaps connecting the driving air flap and the first control air flap with one another through linking components impeded indirectly in its movement beyond the first operating position by the first end-stop arrangement during specified normal operation. Consequently, the correct and expected impeding of the movement of the first control air flap on reaching the first operating position can be evaluated as a signal for correct functioning of the entire air flap arrangement. The movement impairment of only the first control air flap is transmitted via the individual linking components all the way to the driving air flap. Every air flap situated in the force transmission path between the movement drive and a counter-abutting section of the first end-stop arrangement on the air-flap carrier side, including the driving air flap, and where applicable one or several intermediate air flaps and the control air flap, or a linking component situated in this force transmission path, is necessary for the correct termination of the displacement movement of the plurality of air flaps towards the first operating position. Even if only one air flap out of the plurality of air flaps fails or even if only one linking component in the force transmission path between the movement drive and the counter-abutting section of the first end-stop arrangement on the air-flap carrier side fails, the movement drive is no longer blocked as expected by the control air flap and the first end-stop arrangement on reaching the first operating position, but can instead continue moving, in a departure from specified normal operation. By detecting this excessive movement, which indicates a state departing from specified normal operation, the complete plurality of the air flaps following one another in the sequential direction and linked with one another for joint movement can be checked for correct functioning. In this process, damage to each individual air flap or to each individual linking component can be identified.

To clarify: the driving air flap is that air flap out of the plurality of air flaps which is linked with the movement drive in a force-transmitting manner without an intermediate arrangement of a further air flap. Between the movement drive and the driving air flap there can be arranged a gear unit in order to match a movement speed of an output element of the movement drive to a desired movement speed of the air flaps.

In order to achieve the finest possible resolution of the onboard diagnosis, each linking component connects with one another exactly two air flaps adjacent in the sequential direction. The plurality of air flaps comprises therefore preferably exactly one air flap more than it exhibits linking components, as long as, which is preferable due to the lower manufacturing and assembly cost, only one linking strand exists along which the air flaps are linked with one another through linking components in a force-transmitting manner. So as not to disturb, as far as possible, the flow-through of the air outlet opening by the linking strand, the linking strand is preferably situated at a longitudinal end of the respective air flaps. This is preferably that longitudinal end of the air flaps which is opposite the longitudinal end at which the movement drive transmits its driving force to the driving air flap.

In a way that is known per se, each air flap can exhibit an operating lever which projects from a flap surface, with which through displacement of the air flaps relative to the air flap carrier a change in the flow-through cross-sectional area of the air outlet opening is achieved.

Although the plurality of air flaps can be adjustable by translation between their blocked operating position and their opened operating position, due to the smaller required movement space and/or due to the advantageous shape of the movement space, respective, they are preferably adjustable through a swiveling movement, especially preferably only through a swiveling movement, between their blocked operating position and their opened operating position. The plurality of air flaps is preferably arranged with parallel virtual swivel axes at the air flap carrier, where the virtual swivel axes follow one another in the sequential direction. Preferably the virtual swivel axes of the individual air flaps out of the plurality of air flaps lie in a common virtual plane.

A linking component preferably forms together with the air flaps and the air flap carrier a parallelogram four-rod linkage mechanism, such that the linking component transmits a movement between the air flaps connected through it without step-up or step-down gearing. The virtual articulation axes of a linking component, each of which is formed at the connection point of an air flap with the linking component, therefore preferably exhibit the same distance from one another as the swivel axes of the air flaps linked by the linking component. This preferably applies to all air flaps from the driving air flap to the control air flap.

Preferably each linking component which links with one another two air flaps adjacent to each other in the sequential direction, is articulated in a swiveling manner at the operating lever of the air flaps.

In principle it can suffice to check only one of the aforementioned operating positions for an onboard diagnosis. A more detailed picture of any damage can, however, be obtained if the respective other, then second operating position can also be utilized for checking the correct functioning of the air flap arrangement. For this reason, according to an advantageous further development of the present invention it is provided that a second operating position, different from the first one, out of the blocked operating position and the opened operating position is defined by a second end-stop arrangement which impedes movement beyond the second operating position of a second control air flap arranged in the sequential direction at a distance from the driving air flap during specified normal operation for changing the flow-through cross-sectional area of the air outlet opening, where only the second control air flap is impeded directly by the second end-stop arrangement during specified normal operation in its movement beyond the second operating position and a second group of air flaps, comprising the driving air flap and the intermediate air flaps which connect the driving air flap and the second control air flap with one another through linking components, is impeded indirectly by the second end-stop arrangement during specified normal operation in its movement beyond the second operating position.

Admittedly, it is in principle conceivable for the first control air flap and the second control air flap to be different air flaps. Preferably, however, the first control air flap and the second control air flap are the same air flap. It is preferably that air flap which in the sequential direction is furthest away from the driving air flap and/or that air flap which is separated from the driving air flap by the greatest possible number of linking components arranged in-between.

In order to be able to detect the excessive movement path discussed above, the air flap arrangement can exhibit a detection device which interacts with the movement drive in such a way that the detection device detects whether a movement operation of the movement drive for displacing the plurality of air flaps between the blocked operating position and the opened operating position corresponds to a displacement of the plurality of air flaps towards a special position located outside the displacement region between the blocked operating position and the opened operating position. The detection device can be part of the movement drive, for instance part of a drive control unit of the movement drive, or it can be a separate apparatus which can even be arranged at a spatial distance from the air flap carrier.

In order to detect the special position, the movement drive does not have to be stationary since a special position is also compulsorily reached when the still continuing movement operation corresponds to a position outside the displacement region expected and/or predetermined for the correct displacement of the air flaps. If the movement operation of the movement drive still continues, normally the movement drive can only reach states which correspond to still further special positions which likewise lie outside the expected and/or predetermined displacement region. This is because a reversal of the direction of movement of the movement drive within a movement operation for correct displacement of the plurality of air flaps between the blocked operating position and the opened operating position is normally not provided. The movement drive can, however, be stationary for detecting the special position in order to detect an unambiguous, not further changing state of the movement drive for diagnostic purposes.

The detection device can be configured to perform the detection whether the end of the operation corresponds to the special position, based on a duration of the movement operation and/or a position of an output element of the movement drive. The detection device can therefore comprise a clock for measuring a duration, for instance a duration of an operation of the movement drive, and/or at least one position sensor for detecting a position of the output element. Preferably the movement drive is a rotary electric motor. Then parts of the electric motor can also be parts of the position sensor.

Since at least one operating position out of the blocked operating position and opened operating position is defined by an end-stop arrangement, the movement drive of the correctly functioning air flap arrangement is compulsorily stopped on approaching the operating position in question. When, however, the force transmission path between the movement drive and the counter-abutting section on the air-flap carrier side of the first and/or the second end-stop arrangement is interrupted by the loss or defect of at least one air flap and/or by the loss or defect of at least one linking component, the movement drive can be operated for longer than during specified normal operation on approaching the operating position since the end-stop arrangement then does not act back on it, such that the duration of the operation of the movement drive is an indicator for the functionality of the air flap arrangement.

In order to prevent, in the event of a defective air flap arrangement, the movement drive moving the driving air flap and any intermediate air flaps still connected with it via linking components into unfavorable positions, the air flap arrangement can comprise a first OBD end-stop arrangement which impedes movement of the driving air flap in a first direction of movement into a region outside the displacement region between the blocked operating position and the opened operating position.

So that in the event of damage a defined end-position can be approached for each of the two operating positions, the air flap arrangement can comprise a second OBD end-stop arrangement which impedes movement of the driving air flap in a second direction of movement opposed to the first one into a region outside the displacement region between the blocked operating position and the opened operating position.

For the OBD end-stop arrangement, the same applies in connection with the driving air flap that applies for the aforementioned end-stop arrangement in connection with the control air flap, namely preferably both for the first and for the second OBD end-stop arrangement and both for the first and for the second aforementioned end-stop arrangement: a section configured for joint movement with the air flap, i.e. either a section of the air flap itself or for example the operating lever of the respective air flap, exhibits an abutment section configured for abutting on an air-flap carrier side counter-abutting section. A section connected preferably rigidly with the air flap carrier or a section of the air flap carrier forms the counter-abutting section, off which the abutment section abutting on it can be lifted only in one direction.

In order to avoid undesirable direct force transmission between two linking components, since this could mask damage to the air flap arrangement, according to a preferable further development of the present invention it is the case for at least one intermediate air flap, preferably for every intermediate air flap, that a first linking component which links the intermediate air flap with the air flap adjacent to it against the sequential direction for joint displacement movement, and a second linking component which links the intermediate air flap with the air flap adjacent to it in the sequential direction for joint displacement movement, are free from a direct connection with one another. Preferably the first and the second linking component are articulated at a common trunnion of the intermediate air flap, where the trunnion preferably projects from the operating lever. It should not, however, be precluded that every linking component at the intermediate air flap is linked with the intermediate air flap via its own trunnion rotatably about the respective trunnion axis. The manufacturing cost associated with this, however, is unnecessarily high. Quite generally, therefore, it is the case preferably for at least one intermediate air flap, particularly preferably for all intermediate air flaps, that a first linking component which links the intermediate air flap with the air flap adjacent to it against the sequential direction for joint displacement movement, and a second linking component which links the intermediate air flap with the air flap adjacent to it in the sequential direction for joint displacement movement, are articulated at a common trunnion connected rigidly with the intermediate air flap.

The present air flap arrangement is configured in such a way that an operational state of the air flap arrangement lying outside the specified normal operation leads to interruption of the force transmission path from the movement drive up to the first and/or second end-stop arrangement. This interruption can, as set forth above, be easily detected by the detection device. So that this interruption of the force transmission path in the event of damage to an air flap and/or to a linking component ends as securely as possible, preferably a linking component is secured to only one of two air flaps connected via the linking component against removal from the air flap, in particular against removal from the trunnion at which the linking component is preferably articulated. For example, one of the linking trunnions can exhibit a springy rear engagement formation, for instance a springy latch projection, whereas the respective other one of the linking trunnions does not engage a recess of the linking component from behind. The linking component would then be quite readily removable from the other linking trunnion along the trunnion axis, were it not secured by the one trunnion.

In a further development of the previously developed idea, it is possible for only the linking component articulated at the driving air flap and the linking component articulated at the control air flap of a component, in particular the trunnion, the driving air flap, and/or of the control air flap respectively to be secured against loss. The two linking components going out from the driving air flap and from the control air flap can overlap a linking component located between, which links only two intermediate air flaps with one another, thus securing it against removal from the intermediate air flaps. In the opposite direction, the operating lever of the respective intermediate air flap can form a physical movement barrier for the linking component of the two intermediate air flaps, such that the linking component of the intermediate air flaps is arranged at one end between the linking component going out from the driving air flap and the operating lever of the one intermediate air flap and at the other end between the linking component going out from the control air flap and the operating lever of the other intermediate air flap.

To achieve the greatest possible length of consecutive air flaps which can be checked for correct functioning with the system described here, it is preferably provided that the driving air flap on the one hand and the first and/or second control air flap on the other are each respectively the outermost air flaps arranged at opposite end-regions of the plurality of air flaps following one another directly along the sequential direction.

The present invention also concerns a motor vehicle fitted with at least one air flap arrangement described above. The at least one air flap arrangement is preferably arranged at the motor vehicle's front, for instance at the radiator grille.

The air flap arrangement and/or the motor vehicle can exhibit a control device which during start-up of the motor vehicle by the driver is configured as a test routine to approach at least one operating position, preferably both operating positions, of the air flaps and to check whether the respective normal operational end-positions are reached correctly as end-positions or not. If not, an error message can be output.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A rough schematic top view of an air flap arrangement according to the invention of the present application, where the air flaps are in the blocked operating position,

FIG. 2 A rough schematic cross-sectional view of the air flap arrangement of FIG. 1 along the sectional plane II-II of FIG. 1,

FIG. 3 A rough schematic cross-sectional view of the air flap arrangement of FIG. 1 with the air flaps in the opened operating position, and

FIG. 4 A rough schematic cross-sectional view of the air flap arrangement of FIG. 1 in a damaged situation through loss of the lower intermediate air flap.

### DESCRIPTION OF PREFERRED EMBODIMENTS

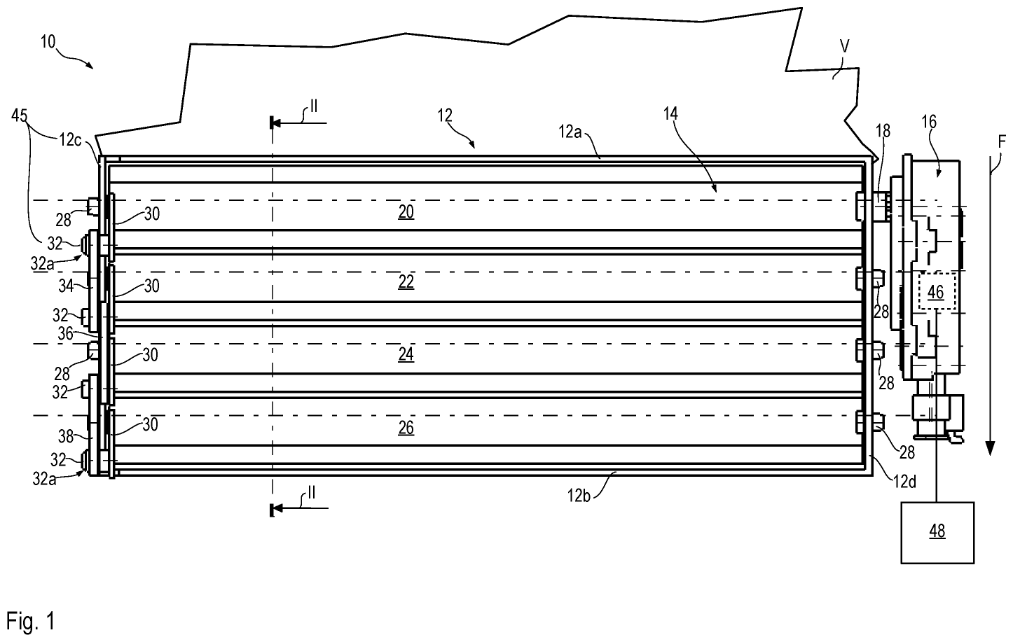

Referring now to the drawings wherein the showings are for the purpose of illustrating preferred and alternative embodiments of the invention only and not for the purpose of limiting the same, in FIG. 1, an embodiment of an air flap arrangement according to the invention depicted in a rough schematic top view is labeled generally by 10. The air flap arrangement 10 comprises an air flap carrier 12 with an upper cross-brace 12a, with a lower cross-brace 12b, with a left lateral frame 12c in in the view of FIG. 1, and with a right lateral frame 12d. The air flap carrier 12 surrounds an air outlet opening 14, which in the view of FIG. 1 allows through-flow of air orthogonally to the drawing plane of FIG. 1 when the air flap arrangement 10 assumes an operational state suitable therefor. Air flap arrangement 10 is arranged on a motor vehicle V, for instance in the region of a radiator grille.

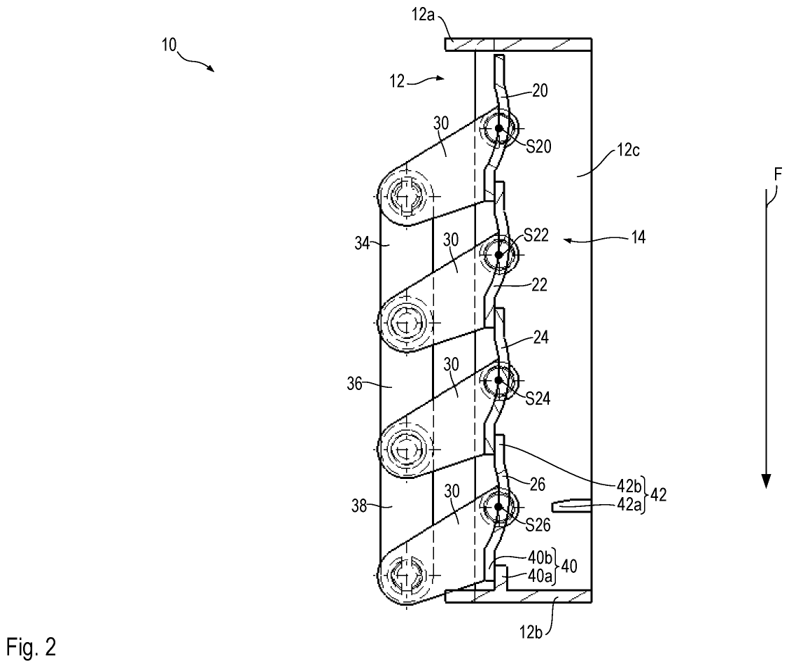

The air flap arrangement 10 exhibits a movement drive 16 in the form of a rotary electric motor, arranged as an example at the right lateral frame 12d. An output shaft 18 is linked with a driving air flap 20 in a torque-transmitting manner. The driving air flap 20 is the air flap located nearest to the upper cross-brace 12a. Its swivel axis, labeled by S20 in FIG. 2, proceeds in parallel to the cross-braces 12a and 12b.

In a sequential direction F, the driving air flap 20 is followed by an upper intermediate air flap 22, a lower intermediate air flap 24, and a control air flap 26.

All air flaps 20, 22, 24, and 26 are preferably configured identically and are swivel-mounted via longitudinal-end mounting trunnions 28 on the respective nearest lateral frames 12c and 12d about their swivel axes S20, S22, S24, and S26 shown in FIG. 2 and proceeding orthogonally to the drawing plane of FIG. 2. Therefore the air flaps 20, 22, 24, and 26 straddle the air outlet opening 14.

In the depictions of FIG. 1 and FIG. 2, the air flaps 20, 22, 24, and 26 are in their respective blocked operating position, in which they cover the air outlet opening 14 maximally and essentially prevent airflow through the air outlet opening 14.

Each air flap 20, 22, 24, and 26 exhibits at its longitudinal end furthest from the movement drive 16 and nearest to the lateral frame 12c an operating lever 30, which also serves for transmitting force and movement between the air flaps 20, 22, 24, and 26. From each operating lever 30 there projects a trunnion 32, namely in the depicted example in the direction away from the movement drive 16. The trunnion longitudinal axes of the trunnion 32 are parallel to one another and to the air flap swivel axes S20, S22, S24, and S26.

The trunnions 32 of the driving air flap 20 and of the upper intermediate air flap 22 and hence the driving air flap 20 and the upper intermediate air flap 22 are linked with one another by a first linking component 34. The upper intermediate air flap 22 and the lower intermediate air flap 24 are linked with one another via their trunnions 32 by means of a second linking component 36. The lower intermediate air flap 24 and the control air flap 26 are linked via their trunnions 32 by means of a third linking component 38.

The linking components 34, 36, and 38 form together with the air flaps 20, 22, 24, and 26 a force transmission path from the movement drive 16 to a first counter-abutting section 40a configured at the air flap carrier 12, shown in FIG. 2, on which a first abutment section 40b of the control air flap 26 abuts in the depicted blocked operating position. The first counter-abutting section 40a and the first abutment section 40b form a first end-stop arrangement 40. The latter limits the movement path of the control air flap 26 and hence with a functioning air flap arrangement 10 the movement path of all air flaps 20, 22, 24, and 26 during their displacement into the blocked operating position depicted in FIGS. 1 and 2.

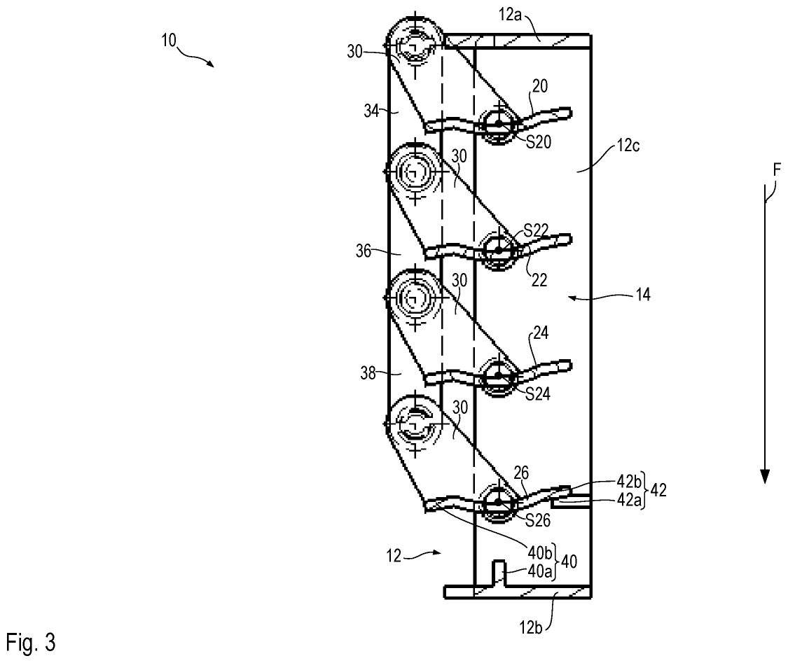

Likewise there is already discernible in FIG. 2 a second counter-abutting section 42a on the air flap carrier 12 and a second abutment section 42b on the control air flap 26, which together form a second end-stop arrangement 42 which defines the opened operating position depicted in FIG. 3.

FIG. 3 depicts the air flap arrangement 10 displaced into the opened operating position. In the opened operating position, the second abutment section 42b of the control air flap 26 abuts on the second counter-abutting section 42a. With an undamaged air flap arrangement 10, the end-stop arrangements 40 and 42 thus limit in their specified normal operation, which concerns the displacement between the operating positions depicted in FIGS. 2 and 3, the movement path of the air flaps 20, 22, 24, and 26 and consequently also the movement path of the output shaft 18 of the movement drive 16.

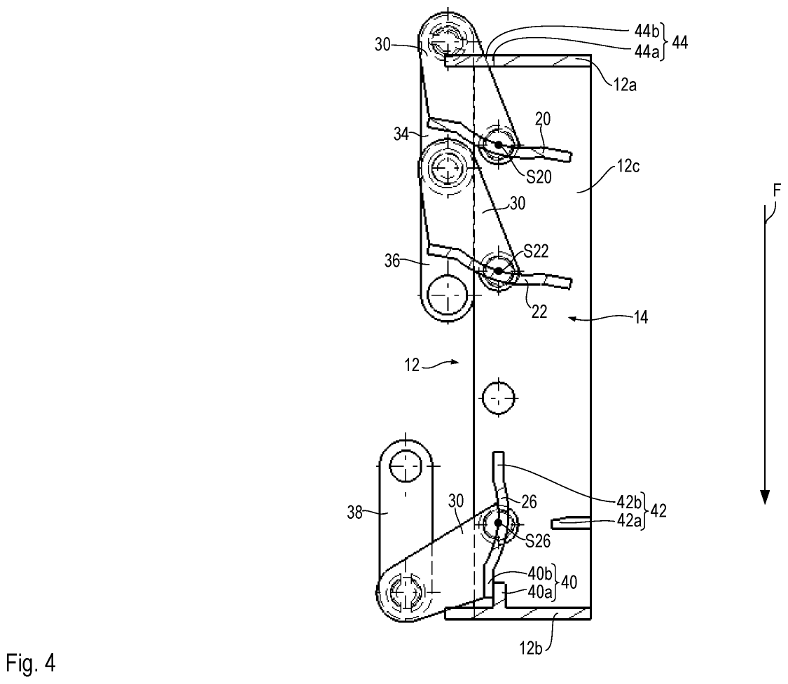

FIG. 4 depicts a damage event in which the lower intermediate air flap 24 has been lost, for example through a stone impact. The force transmission path from the movement drive 16 up to the first counter-abutting section 40a is consequently interrupted. The control air flap 26 is still situated in the blocked operating position into which it has most recently been displaced together with the air flaps 20 and 22 and with the still present lower intermediate air flap 24.

Following loss of the lower intermediate air flap 24, the air flap arrangement 10 was displaced into the opened operating position, which however was only performed along the still functioning residual force transmission path for the driving air flap 20 and for the upper intermediate air flap 22. Consequently, an abutment of the control air flap 26 on the second counter-abutting section 42a which in any case is no longer effected, could not act back on the movement drive 16.

The movement drive 16 has therefore displaced the driving air flap 20 and the upper intermediate air flap 22 linked with it so far in the direction of the opened operating position, until an OBD abutment section 44b of the operating lever 30 of the driving air flap 20 has ended up in abutment on an OBD counter-abutting section 44a. The displacement movement of the movement drive 16 has ended with the production of the abutment engagement between the OBD abutment section 44b and the OBD counter-abutting section 44a. The OBD counter-abutting section 44a and the OBD abutment section 44b form a first OBD end-stop arrangement 44.

The trunnion 32 of the driving air flap 20 and the lateral frame 12c form a second OBD end-stop arrangement 45 (s. FIG. 1), which acts in the opposite direction of movement and ends the movement of the movement drive in the direction of the blocked operating position, if this has not occurred previously through the second end-stop arrangement 42. As with the first OBD end-stop arrangement 44, in the case of the second OBD end-stop arrangement 45 too, an abutment engagement takes place only outside the usual specified displacement operation and/or displacement region at a special position which is reached only in the event of a damaged air flap arrangement 10.

A detection and control device 46 integrated into the movement drive 16 (see FIG. 1) detects the movement path of the movement drive 16 and compares it with a reference movement path which according to a predetermined calibration suffices for reaching the opened operating position.

The detection and control device 46 determines that the movement path travelled by the movement drive 16 in the last movement operation was longer than the reference movement path, whence therefore an end position of the movement drive 16 and the driving air flap 20 is a special position lying outside the specified displacement region.

The detection and control device 46 thereupon outputs an error message to a higher-level control unit, for instance a motor vehicle control unit 48. Instead of a combined detection and control device 46, a detection device and a control device configured separately from it but linked with the detection device for signal transmission can also be envisaged.

The detection result of the control device 46 would be the same for the loss of any one air flap 20, 22, 24, and 26 and for the loss of any arbitrary linking component 34, 36, and 38. The same applies mutatis mutandis to a displacement of the air flap device 10 into the blocked operating position in the absence of one of the aforementioned components.

It needs adding that only the trunnions 32 of the driving air flap 20 and of the control air flap 26 secure the linking components 34 and/or 38 respectively against stripping along the trunnion's longitudinal axis in the direction away from the respective operating lever 30. The aforementioned trunnions 32 exhibit a trunnion head 32a forming a springy latch formation. The remaining trunnions merely penetrate through apertures in the linking components 34, 36, and 38 without engaging with these from behind.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. An air flap arrangement comprising an air flap carrier with an air outlet opening which penetrates through the air flap carrier, where at the air flap carrier there are mounted movably a plurality of air flaps arranged following one another directly along a sequential direction, which are arranged at the air flap carrier projecting into the air outlet opening or straddling the air outlet opening, where each air flap out of the plurality of along the sequential direction following one another directly air flaps is adjustable between a blocked operating position in which the respective air flap decreases more strongly a flow-through cross-sectional area of the air outlet opening, and an opened operating position in which the respective air flap decreases less strongly the cross-sectional area, where each two air flaps directly adjacent in the sequential direction are linked by a linking component for common movement between their blocked operating position and their opened operating position, where the air flap arrangement comprises a movement drive which is linked with an air flap as a driving air flap out of the plurality of air flaps following one another directly along the sequential direction for the transmission of a driving force, where a first operating position out of the blocked operating position and the opened operating position is defined by a first end-stop arrangement which during specified normal operation impedes a movement beyond the first operating position of a first control air flap arranged in the sequential direction at a distance from the driving air flap out of the plurality of air flaps following one another directly along the sequential direction for changing the flow-through cross-sectional area of the air outlet opening, wherein only the first control air flap directly and a first group of air flaps, comprising the driving air flap and the intermediate air flaps which connect the driving air flap and the first control air flap with one another through linking components indirectly, are impeded by the first end-stop arrangement during specified normal operation in their movement beyond the first operating position.

12. The air flap arrangement according to claim 11, wherein a second operating position different from the first one out of the blocked operating position and the opened operating position is defined by a second end-stop arrangement which during specified normal operation impedes movement beyond the second operating position of a second control air flap arranged in the sequential direction at a distance from the driving air flap for changing the flow-through cross-sectional area of the air outlet opening, where only the second control air flap directly and a second group of air flaps, comprising the driving air flap and the intermediate air flaps which connect the driving air flap and the second control air flap with one another through linking components indirectly, are impeded by the second end-stop arrangement during specified normal operation in their movement beyond the second operating position.

13. The air flap arrangement according to claim 12, wherein the first control air flap is the second control air flap.

14. The air flap arrangement according to claim 11, wherein the air flap arrangement exhibits a detection device which interacts with the movement drive in such a way that the detection device detects whether a movement operation of the movement drive for displacement of the plurality of air flaps between the blocked operating position and the opened operating position corresponds to a displacement of the plurality of air flaps towards a special position lying outside the displacement region between the blocked operating position and the opened operating position.

15. The air flap arrangement according to claim 14, wherein the detection device performs the detection whether the end of the operation corresponds to the special position, based on a time duration of the movement operation and/or a position of an output element of the movement drive.

16. The air flap arrangement according to claim 11, wherein the air flap arrangement comprises a first OBD end-stop arrangement which impedes movement of the driving air flap in a first direction of movement in a region outside the displacement region between the blocked operating position and the opened operating position.

17. The air flap arrangement according to claim 16, wherein the air flap arrangement comprises a second OBD end-stop arrangement which impedes movement of the driving air flap in a second direction of movement opposed to the first direction of movement into a region outside the displacement region between the blocked operating position and the opened operating position.

18. The air flap arrangement according to claim 11, wherein for at least one intermediate air flap it is the case that a first linking component which links the intermediate air flap with the air flap adjacent to it against the sequential direction for joint displacement movement and a second linking component which links the intermediate air flap with the air flap adjacent to it in the sequential direction for joint displacement movement are free from a direct connection with one another.

19. The air flap arrangement according to claim 11, wherein for at least one intermediate air flap it is the case that a first linking component which links the intermediate air flap with the air flap adjacent to it against the sequential direction for joint displacement movement, and a second linking component which links the intermediate air flap with the air flap adjacent to it in the sequential direction for joint displacement movement are articulated at a common trunnion connected rigidly with the intermediate air flap.

20. The air flap arrangement according to claim 12, wherein the driving air flap on the one hand and the first and/or the second control air flap on the other are each respectively the outermost air flaps arranged at opposite end-regions of the plurality of air flaps following one another directly along the sequential direction.
